(19) United States
(12) Patent Application Publication
(10) Pub. No.: US 2007/0040529 A1
(43) Pub. Date: Feb. 22, 2007

(54) Stepping motor control system and method for controlling a stepping motor using closed and open loop controls

(75) Inventors: Takashi Takebayashi, Irvine, CA (US); David S. Cho, Anaheim, CA (US); Pavel Tomov, Irvine, CA (US); Dipen Gokhale, Cerritos, CA (US)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Corporation of America, Indianapolis, IN (US)

(21) Appl. No.: 11/206,943

(22) Filed: Aug. 19, 2005

(51) Int. Cl. G05B 19/40

(52) U.S. Cl. 318/685

(57) ABSTRACT

A stepping motor is driven in both closed-loop and open-loop modes while initiating microstepping after a predetermined threshold velocity has been reached. A feedback device such as an encoder is mounted on the stepping motor shaft and the encoder keeps track of the mechanical position of the rotor. Based on feedback from the encoder, stator phases are activated to maintain a 90° phase advance and produce maximum torque. A lead angle compensation technique is used to advance the motor lead angle, to allow for the excitation currents to reach maximum even at higher speeds. The stepping motor controller employs this strategy in order to produce maximum torque across a wide range of motor speeds and actuator motions.

### FIELD OF THE INVENTION

The present invention relates to a control system and method for controlling a stepping motor having plural phase windings.

### BACKGROUND OF THE INVENTION

Stepping motors, which are typically driven without a feedback device, have been used in open-loop positioning systems for many years. However, such open-loop stepping systems frequently exhibit undesirable behaviors such as stepping resonance and loss of synchronization.

Nevertheless, stepping motors are low in cost and are used extensively and at high volume in various industries. Further, because they have many poles operated using plural phase windings, stepping motors produce high torque at a given motor winding current. Such characteristics are particularly suited for a variable-speed positioning controller, and allow the need for auxiliary gear reduction mechanisms, for mechanical force-speed conversion, to be eliminated or at least minimized.

Prior techniques using a closed-loop feedback control of stepping motors are also known. A seminal article on closed-loop control of stepping motors is “Application of the Closed Loop Stepping Motor,” Trans. on Automatic Control, Vol. AC-13, No. 5 (October 1968), by T. R. Fredriksen. With reference to FIG. 15, the features of this closed-loop control system shall briefly be described.

First, an encoder 202, for detecting a position represented by the rotational angle of a motor 201, includes a number of output channels, which is the same as the phase number of the motor 201. For example, in the case of the illustrated four-phase motor 201, the encoder 202 comprises four channel output signals produced by light sources 205 and detectors 204. Accordingly, the excitation phase can easily be ascertained during operation of the motor 201. Secondly, phase windings 203a to 203d appropriate for producing currents based on the output signals from the encoder 202 are provided, whereby the rotational conditions for the motor 201, namely, halting, acceleration, deceleration, steady rotation and high-speed rotation, are controlled by a control circuit 207. Thirdly, the motor is controlled by determining beforehand the rotational angle displacement, up to a final target rotational angle at a predetermined position, together with the rotational conditions of the motor 201 at the time of passing the final target rotational angle and/or by determining beforehand the remaining pulse count needed to produce such an angular displacement, together with the excitation conditions at the time of passing therethrough.

Such a closed-loop control for this type of stepping motor, in particular, improves high-speed performance. However, when load fluctuations occur during operation of the motor, large vibrations are generated when the motor is halted, and proper positioning of the motor cannot be completed, producing a disadvantage in that the time required for proper positioning is increased.

Another known technique for alleviating some of the above defects has been proposed in Japanese Examined Patent Publication No. 57-34758. With the basic closed-loop control of Fredriksen as a foundation, a feedback circuit including a rotational angle loop, a rotational angular velocity loop, and a current loop are introduced, and an external command signal is added thereto, so that by controlling the winding current of the motor with respect to load fluctuations during operation thereof, load fluctuation characteristics are improved. Secondly, when loads applied to the motor are increased, the rotational angular velocity of the motor is lowered. In order to compensate for the lowered rotational angular velocity, an excitation circuit operates for increasing the coil winding current, producing an effect that mitigates against the lowering of the rotational angular velocity. Thirdly, in the case that the load is lessened, the above features are operated oppositely, so that in the same way variations in rotational angular velocity can be prevented. With respect to load fluctuations of the motor, the excitation circuit controls both increasing and decreasing of electrical energy to the motor. Thus, load fluctuation characteristics are improved, and vibrations that occur upon stopping the motor can be suppressed to a certain degree.

However, in the system described in Japanese Examined Patent Document No. 57-34758, since an external command signal is used, which finely controls time-based variations in the rotational angle of the stepping motor, when excessive load disturbances are generated, the motor may fall into a low velocity, or even a stopped condition. In such a condition, after passage of a certain degree of time, even if the load disturbance is removed, the external command signals have already terminated and the motor cannot achieve its final target rotational angle. Further, there is the possibility for the motor to collapse into an uncontrollable condition. Up to the present, this has been a problem inherent in the feedback control of stepping motors, which has been difficult to resolve using conventional control methods.

Another closed-loop control method, which addresses some of the deficiencies described above, has been disclosed in Japanese Laid-Open Patent Application No. 11-252994. The principal feature of this control method is to further alleviate load fluctuation characteristics and thus enable a more stable operational control.

As shown in FIG. 16, Japanese Laid-Open Patent Application No. 11-252994 discloses a stepping motor control apparatus comprising a stepping motor 307, a drive means 304 for driving the stepping motor 307, detection means 308, including an encoder for detecting an output rotation angle of the stepping motor 307 and outputting a rotation angle signal, command means 309 for storing a velocity coefficient from initiation to stopping of the motor and outputting a target command signal based on the velocity coefficient, comparing means 301 for comparing the target command signal with the rotation angle signal, and a control means 302 for determining and outputting a drive lead angle and a drive current for the stepping motor based on the comparison result, wherein an observer circuit 305 is provided for outputting a lead angle correction signal and a current correction signal, in order to correct the drive lead angle and drive current output by the control means, by simulating the operating characteristics of the stepping motor under use, based on a the target command signal and the rotation angle signal.

Motors that operate under a closed-loop control, using lead angle and current correction as described above, possess the advantage of high torque even when operating at high speeds. However, strict closed-loop control of stepping motors can result in other disadvantages. Particularly, when transitioning between high and low speeds while the motor is driven in full steps, torque ripple may occur, which can result in undesirable actuator vibration. In addition, when the stepping motor is brought to a stopped position, closed-loop feedback can cause the system to enter into a motor hunting cycle, which induces intrinsic motor vibrations when the motor is placed in a position holding mode.

### SUMMARY OF THE INVENTION

An object of the present invention is to provide a stepping motor control system and method, using a closed-loop control, which exhibits improved high speed and high torque performance, yet wherein the problems associated with closed-loop control, such as motor hunting and actuator vibrations, are avoided by shifting between different operating modes at predetermined conditions during the motion profile of an actuator driven by the stepping motor.

A further object of the present invention is to provide a stepping motor control system and method, which utilizes closed-loop, microstepping, and open-loop control methods, dependent on operating conditions of the stepping motor.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an electric actuator according to which the principles of the present invention are applied;

FIG. 2 is a transverse cross-sectional view taken along line II-II of FIG. 1;

FIG. 3 is a fragmentary longitudinal cross-sectional view of the electric actuator shown in FIG. 1;

FIG. 4 is a diagram illustrating the configuration of a stepping motor driven electric actuator, for use in a multi-axis actuator system, with associated control components;

FIG. 5 is a graph illustrating an actuator motion profile, during constant velocity, acceleration and deceleration modes, together with actuator position;

FIG. 6 is a schematic illustration of stepping motor control principles indicating the principal signals used in controlling the stepping motor;

FIG. 7 is a graph illustrating an actuator motion profile, while showing stepping motor control modes used during different motion stages;

FIG. 8 is a block diagram illustrating the control method used for stepping motor position and speed control using a stepping motor driven actuator;

FIG. 9 shows a control screen for setting parameters used in controlling the stepping motor;

FIG. 10 is a flowchart of process steps undertaken for electrical alignment and base offset measurement of the stepping motor;

FIG. 11 is a schematic illustration of the stepping motor undergoing electrical alignment with excitation currents applied to phase windings of the stepping motor;

FIGS. 12A to 12D are schematic illustrations of the stepping motor driven using a full-step drive mode;

FIGS. 13A to 13C show respective current rise time waveforms produced as the motor speed increases;

FIG. 14 is a graph of rotor speed versus torque produced by the stepping motor to illustrate the effect of lead angle compensation;

FIG. 15 illustrates a conventional closed-loop stepping motor control system; and

FIG. 16 illustrates another conventional closed-loop stepping motor control system.

### DETAILED DESCRIPTION OF THE PREFERRED EMBODIMENT

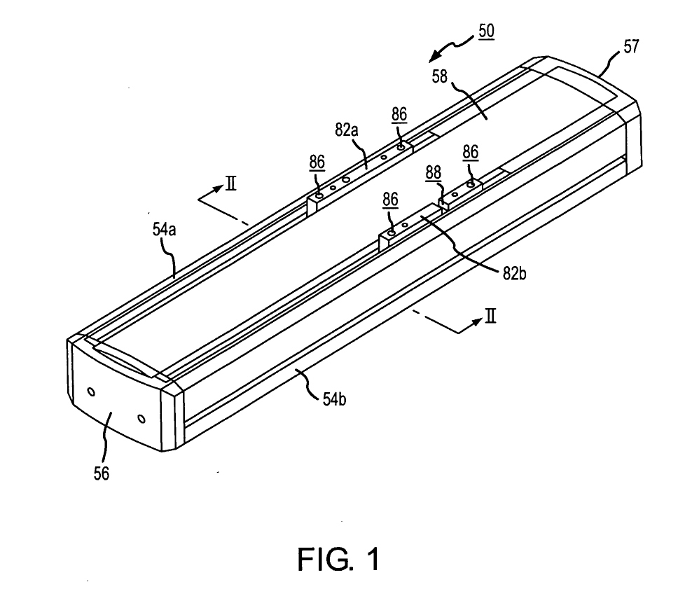

A known type of electric linear actuator, to which the principles of the present invention are applied, is shown in FIGS. 1 through 3.

The electric actuator, generally denoted at 50 in FIGS. 1 through 3, comprises an elongate frame 52 as a base, a pair of elongate side covers 54a, 54b mounted respectively on transversely opposite sides of the frame 52, a pair of end covers 56, 57 mounted respectively on longitudinally opposite ends of the frame 52, and an elongate top cover 58 engaging upper surfaces of the side covers 54a, 54b.

On the frame 52, there are mounted a drive mechanism 60 fixed to one end of the frame 52 and supporting one end of a ball screw 62, a bearing block 64 fixed to the other end of the frame 52 and supporting the other end of the ball screw 62, and a table mechanism 66 linearly displaceable between the drive mechanism 60 and the bearing block 64 by the ball screw 62 upon rotation thereof. A pair of transversely spaced guide members 68a, 68b is fixed to an upper surface of the frame 52 for linearly guiding the table mechanism 66 when the table mechanism 66 is displaced by the ball screw 62. The bearing block 64 comprises a support block 22 mounted on the frame 52, and the other end of the ball screw 62 is rotatably supported in the support block 22 by a bearing 24.

The frame 52 has two transversely spaced grooves 70a, 70b of an identical T-shaped cross section which are defined in a lower surface thereof and extend parallel to each other in the longitudinal direction of the frame 52. The transversely opposite sides of the frame 52 have respective engaging grooves 72a, 72b defined therein and extending longitudinally therealong for attachment of the side covers 54a, 54b. The frame 52 also has longitudinal passageways 74a, 74b, 76a, 76b defined therein for accommodating electric wires or hydraulic fluid conduits. The frame 52 has a pair of attachment grooves 77a, 77b defined in an upper surface thereof near the passageways 76a, 76b for attachment of detectors such as automatic switches or the like. The attachment grooves 77a, 77b also serve as wiring grooves for accommodating leads connected to the detectors.

The side covers 54a, 54b have respective substantially L-shaped hooks 78a, 78b disposed on inner sides thereof for engaging in the respective engaging grooves 72a, 72b. The hooks 78a, 78b can be fitted into respective engaging grooves 72a, 72b when the side covers 54a, 54b are pressed obliquely downward against the transversely opposite sides, respectively, of the frame 52. To detach the side covers 54a, 54b from the frame 52, the side covers 54a, 54b are pulled upwardly away from the transversely opposite sides, respectively, of the frame 52. Therefore, the side covers 54a, 54b can easily be installed on and removed from the frame 52.

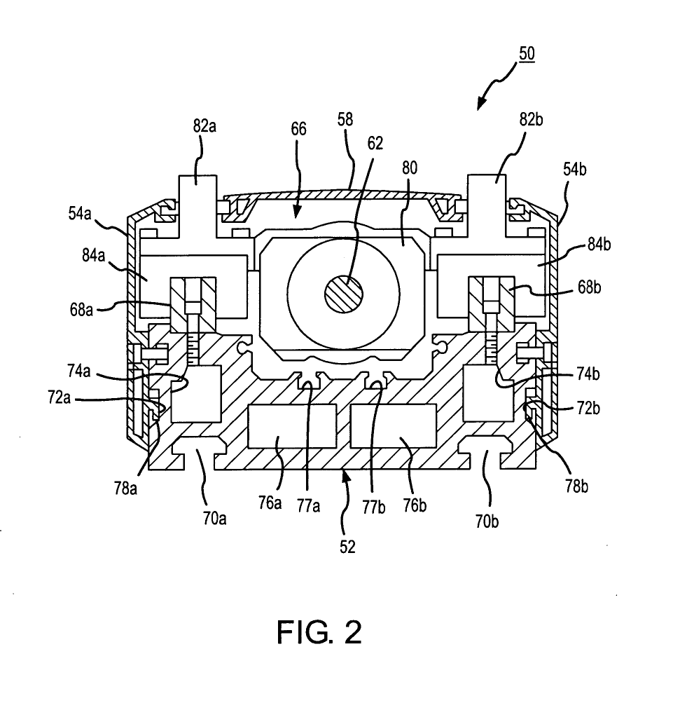

As shown in FIG. 2, the table mechanism 66 comprises a ball screw bushing 80 for converting rotary motion of the ball screw 62 into linear motion, a pair of table blocks 82a, 82b holding transversely opposite sides, respectively, of the ball screw bushing 80, and a pair of holders 84a, 84b having a channel-shaped cross section interposed between the table blocks 82a; 82b and the guide members 68a, 68b. As shown in FIG. 1, the table blocks 82a, 82b have holes 86 defined in their upper surfaces for coupling a member that is mounted on the table blocks 82a, 82b, and the table block 82b has a recess 88 defined in its upper surface for positioning a workpiece highly accurately.

In the case of multi-axis configurations, the table blocks 82a, 82b can support yet another linear actuator thereon, to enable the movement of a table block of the thus-supported actuator in both X and Y directions, for example.

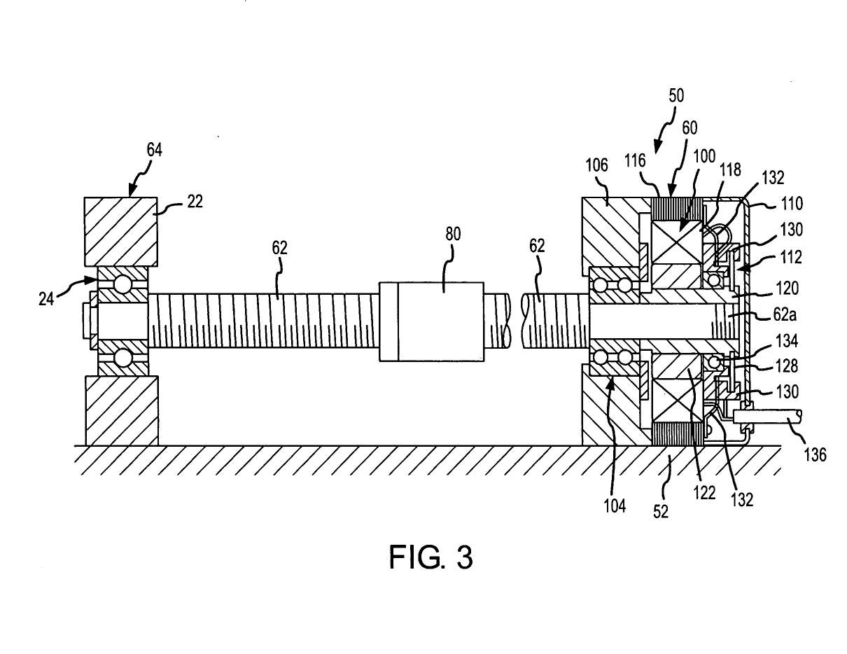

As shown in FIG. 3, the drive mechanism 60 comprises a housing 106 mounted on the frame 52 and having a bearing 104 to which one end of the ball screw 62 is rotatably supported, a motor 100, and an encoder 112 covered by a cover 110. The housing 106 which supports the ball screw 62 serves as a motor body. In the present invention, the motor 100 preferably comprises a two phase stepping motor.

The motor 100 is fixed to the housing 106, and comprises a stator 116 composed of a plurality of separate stator cores that are joined together, a plurality of coils 118 wound around the respective stator cores, and an annular permanent magnet serving as a rotor 122 which is fixedly mounted on a reduced-diameter end 62a of the ball screw 62 through a sleeve 120.

Typically a linear actuator 50, such as the one described above, will be provided as only one actuator in a multi-axis system of actuators, which are connected together as a structural system, for enabling movement of an end effector (for example a gripping tool) in two or more dimensions, for picking up objects (parts) and delivering them to a desired destination, for example an assembly station.

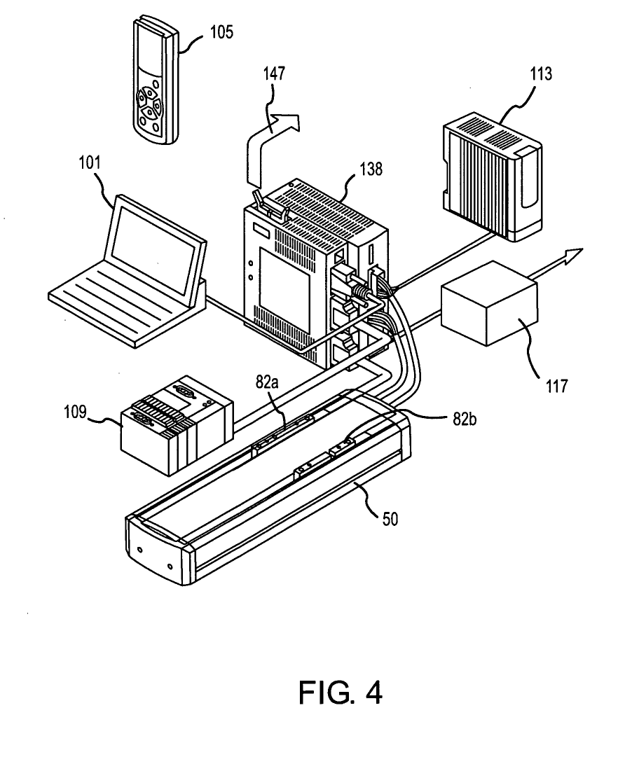

FIG. 4 shows an overall system configuration for controlling an electric linear actuator 50, including a human machine interface (HMI), for setting regular actuator step movements and other parameters. Setting of regular single-step moves for the actuator are performed via the human machine interface (HMI) program which runs on a PC 101, or alternatively, may be set using a teaching box 105. Firmware parameters of the controller 138 are set primarily through a programming feature of the HMI software that runs on the PC 101. The teaching box 105 provides a simplified alternative interface for entering and storing physical characteristics of the actuator 50 and properties of pre-programmed motion steps prior to operation of the actuator 50.

The PC 101 is connected to a serial input port of the controller 138, whereby parameters set via the HMI software can be transferred as data making up a Motion Profile Table (MPT) stored in a data storage area of the controller 138. The serial connection between the PC 101 and controller 138 is bi-directional, so that the MPT data currently stored in the controller 138 can also be uploaded as parameters into the HMI software, for modification if desired.

A Programmable Logic Controller (PLC) 109 for sending sequential step commands to the controller 138 is connected through an I/O port. More specifically, the PLC 109 sends signals to the controller 138 through an I/O port for instructing the controller 138 to execute a given sequence of steps, from among the steps previously entered in the MPT. The controller 138 also outputs signals to the PLC 109 through the I/O port, which indicate each step number as it is being executed. The PLC 109 is also capable of sending commands to start and stop sequence execution, emergency stop, reset and homing.

The linear actuator 50 is connected with the controller 138 through at least two, and potentially three, connecting cables. One cable connects an output from the encoder 112 (see FIG. 3) of the actuator to an encoder connector port, for delivering a signal to the controller which is indicative of the position of a table blocks 82a, 82b. A second cable is provided for connection between power terminals and the motor power leads of the actuator 50. A third optional cable may be used if the actuator 50 is equipped with a known type of breaking mechanism (not shown) in which case signals can be sent from a brake connector for controlling application of the motor brake. The controller 138 also includes a power connector having terminals for input of an AC main power supply to the controller 138 through a circuit breaker 117.

When the actuator 50 is installed for certain vertical applications, a regenerative resistor unit 113 can optionally be connected to the controller 138. For example, as a heavy object transported by the table blocks 82a, 82b falls downward, the motor 100 generates a current which is dissipated through the regenerative resistor unit 113 which consumes and absorbs the regenerative power-generated by the motor 100, slowing the fall of the object in a controlled manner. Although not shown, the regenerative resistor unit 113 can also be incorporated directly into the design of the controller 138, in which case the resistor unit 113 may be contained internally inside the controller 138 casing, without need for any additional connecting cable between the controller 138 and the resistor unit 113.

FIG. 4 shows a configuration for a single linear actuator 50 only. However, a multi-axis configuration commonly is used comprising respective actuators, wherein plural controllers 138 are interconnected through a serial communication line 147 to multi-axis connectors on each respective controller. In such a case, the PC 101 (or alternatively teaching box 105) and the PLC 109 need only be connected to the first of the serial-connected controllers 138, which serves as a master unit, and the other controllers operate as slaves.

An example of such a multi-axis configuration is shown in U.S. Pat. No. 6,718,229 by Takebayashi et al., along with other features of the human machine interface (HMI) used for programming actuator movements. The full disclosure of U.S. Pat. No. 6,718,229 is expressly incorporated by reference into the present specification. As shall be explained in greater detail below, the programming features of the present invention, which are set and implemented through the HMI, pertain to operating the stepping motor 100, which serves as the primary drive means for the electric linear actuator 50.

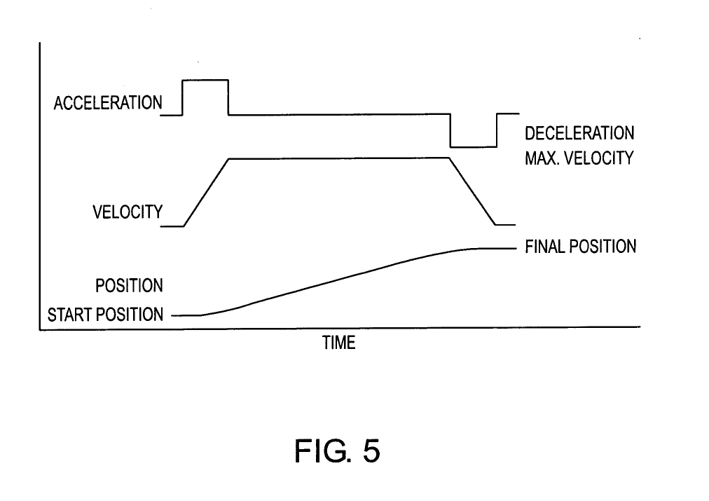

FIG. 5 is a graph for explaining motion of the table of the linear actuator according to the operation data settings. When the actuator table mechanism 66 is moved between a start position and a final position, the movement follows a roughly trapezoidal velocity profile. More specifically, as shown in the middle velocity curve of FIG. 5, the velocity of the actuator first increases linearly while the actuator table is undergoing acceleration, until the actuator reaches a maximum velocity. The actuator then travels at the maximum velocity for a certain period of time until it is necessary for the table block to begin decelerating, at which time the velocity decreases linearly to zero when the table block has reached the desired final position. Depending on input values for acceleration, velocity, deceleration and position, it is possible that the actuator table mechanism 66 will not reach maximum velocity before it becomes necessary for the actuator to decelerate to reach the desired final position. In this case, the table mechanism 66 will accelerate to a point short of the maximum velocity and then immediately decelerate to reach the final position, producing a triangular rather than a trapezoidal profile.

The present invention includes implementation of a closed-loop control for the stepping motor 100, in conjunction with a chopper amplifier and a phase current controller. However, this implementation can be easily adapted to different types of stepper motors, such as variable reluctance (VR) and permanent magnet (PM) motors. In the present specification, for purposes of illustrating a preferred embodiment of the invention, the following descriptions shall focus on a 1.8° hybrid stepping motor, which is common in the industry and produces a high torque output density. Terminology and parameters necessary for understanding operations of the stepping motor 100 are as follows:
Number of (equivalent) rotor poles per phase: Nph
Number of phases: Ph=2 (phases A and B)
Number of (equivalent) stator poles per phase: Nsp=2
Number of poles for all phases together: N=Nph×Ph
Number of electrical steps per revolution: Nel=N/Nsp
Full step (mechanical) angle:
   θₛₜ=360°/(Nph×Ph)
   θₛₜ=360°/N
Full step (electrical) angle:
   θₑₗ=(N/(Ph×Nsp))×θst
   θₑₗ=(Nph/Nsp)×θst
   θₑₗ=360°/(Ph×Nsp)

In the above parameters, for a two-phase stepping motor according to the preferred embodiment, Nph=100 (i.e., there are 50 N poles and 50 S poles). Further, as indicated above, the number of phases Ph=2, and the number of equivalent stator poles per phase Nsp=2. Accordingly, it is seen that the mechanical full step angle θₛₜ for the stepping motor 100 of the preferred embodiment is θₛₜ=360°/(Nph×Ph)=360°/200=1.8°, whereas the corresponding electrical full step angle is θₑₗ=(Nph/Nsp)×θₛₜ=(100/2)×1.8°=360°/(2×2)=90°. It therefore follows, for this type of stepping motor, that in each mechanical full step angle (1.8°) there are 50 electrical (90°) angles. This means that a complete 360° (4×θₑₗ) electrical magnetic field rotation will result in four mechanical full steps (4×θₛₜ7.2°). Stated otherwise, one electrical full step means rotation of the resulting magnetic field vector by 90° (electrical degrees)

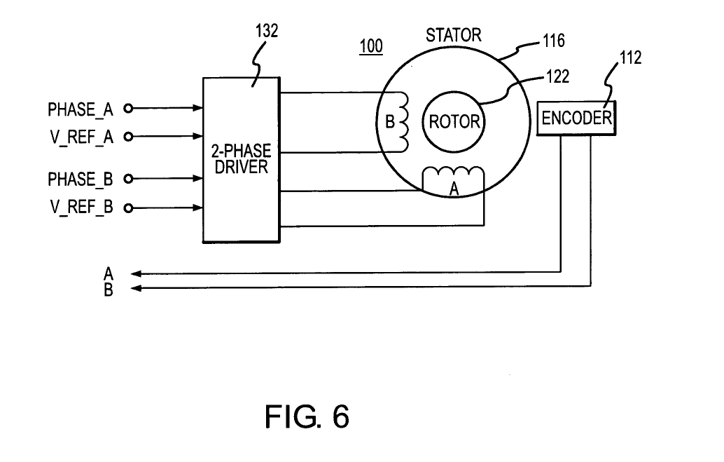

FIG. 6 is a schematic illustration of a two phase stepping motor 100 and indicates the principal signals used in controlling the stepping motor 100. Operation of the permanent magnet stepping motor 100 to produce incremental motion in steps is achieved by interaction between excitations of the stator 116 and the permanent magnet fields of the rotor 122, such that the magnetic field from the stator 116 pulls the rotor 122. A combination of possible driver input variables controls the stator phase currents, which thereby controls the stator magnetic field rotation direction and magnitude. Phase_A (PA) and Phase_B (PB) inputs to a two-phase driver circuit 132 control the sequence of stator phase currents and the directional change produced thereby, whereas the V_Ref_A (IA) and V_Ref_B (IB) inputs control the magnitudes of the stator phase currents. In order to measure the rotary position of the motor 100, as well as for enabling a derived linear position of the actuator table to be determined, an absolute encoder 112 is used to provide A and B feedback signals, as shall be described in greater detail below.

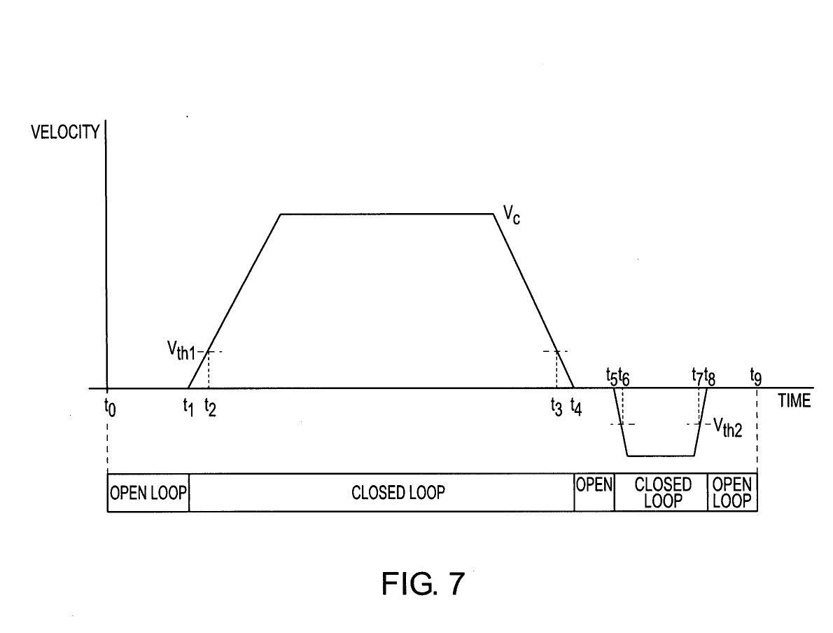

Before explaining in greater detail the control operation modes of the stepping motor 100, a graph illustrating another actuator motion profile, while also showing stepping motor control modes used during different motion stages, shall be described with reference to FIG. 7.

In FIG. 7, the velocity of the table mechanism 66 (see FIG. 2) is shown on the vertical axis and time is shown on the horizontal axis.

Prior to an initial rest stage, the angular position of the rotor must be properly aligned with the excitation field for effectively driving and maximizing motor torque. The present invention uses an electrical alignment method using the high resolution encoder 112, as shall be explained in greater detail below.

At an initial rest stage, from time t₀ to t₁, the table mechanism 66 does not move, while a holding torque is imposed on the stepping motor 100 in an open-loop control mode (described later). Then, at time t₁, the table mechanism 66 begins to accelerate, while the stepping motor 100 is controlled in a closed-loop microstepping control mode (described later), until the table mechanism 66 reaches a first velocity threshold value Vₜₕ₁ at time t₂. After reaching the first velocity threshold value Vₜₕ₁ at time t₂, control of the stepping motor 100 is switched from the microstepping control mode to a closed-loop full-step control mode (described later). The closed-loop full-step control mode is used after the table mechanism 66 has passed the first velocity threshold value Vₜₕ₁, while the table mechanism 66 continues accelerating until reaching a first constant velocity value V_{c}, whereupon the table mechanism 66 travels at the constant velocity V_{c} until the table mechanism 66 begins decelerating and again reaches the first velocity threshold value Vₜₕ₁ at time t₃, at which point control of the stepping motor 100 switches back from the closed-loop full-step control mode to the closed-loop microstepping control mode. The microstepping control mode continues until the table mechanism 66 reaches the second rest stage at time t₄. Similar to the initial rest stage, in the second rest stage from time t₄ to t₅, the table mechanism 66 does not move, while a holding torque is imposed on the stepping motor 100 in an open-loop control mode. After the second rest stage, the table mechanism 66 reverses in direction, following a negative trapezoidal profile. The table mechanism 66 again accelerates, while moving in the reverse direction, until reaching a second velocity threshold value Vₜₕ₂ (which typically should have the same absolute value as the first velocity threshold value Vₜₕ₁). Aside from the table mechanism 66 moving in the reverse direction, control features through the negative trapezoidal profile are basically the same as those of the first positive trapezoidal profile. Namely, after passing the second velocity threshold value Vₜₕ₂ at time t₆, control is switched from the closed-loop microstepping mode to the closed-loop full-step mode. The microstepping mode is reinitiated when the second threshold value Vₜₕ₂ is reached again on the other side of the trapezoidal profile at time t₇, and the closed-loop microstepping mode continues until the table mechanism 66 reaches the next rest stage, from time t₈ to t₉. During the rest stage from time t₈ to t₉, in the same manner as the other rest stages, a holding torque is imposed on the stepping motor 100 in an open-loop control mode.

Moreover, as shown in FIG. 7, during movement of the table mechanism 66 throughout both the positive and negative trapezoidal motion profiles, the stepping motor is operated using the closed-loop control mode, while switching between microstepping and full-step control modes.

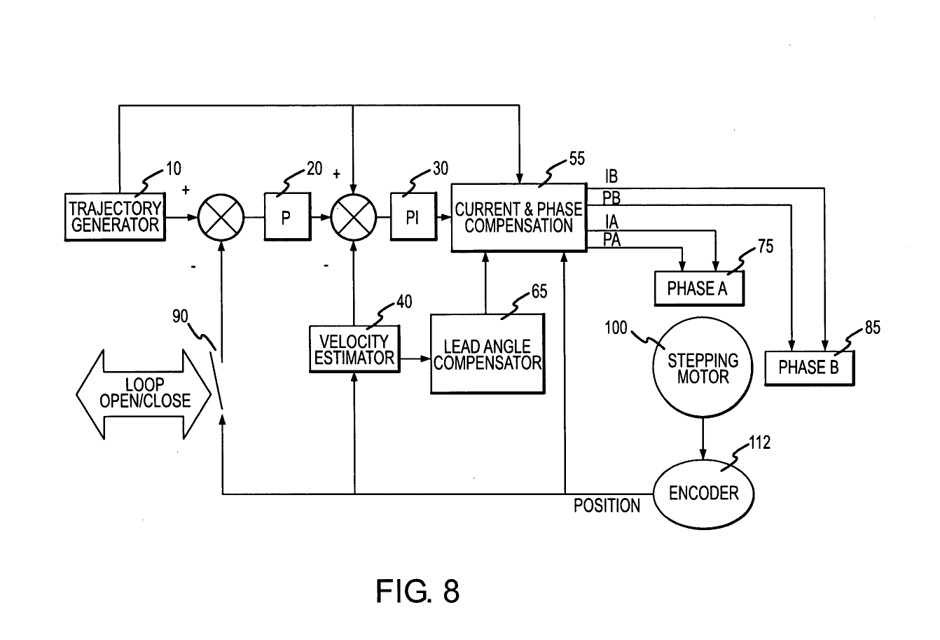

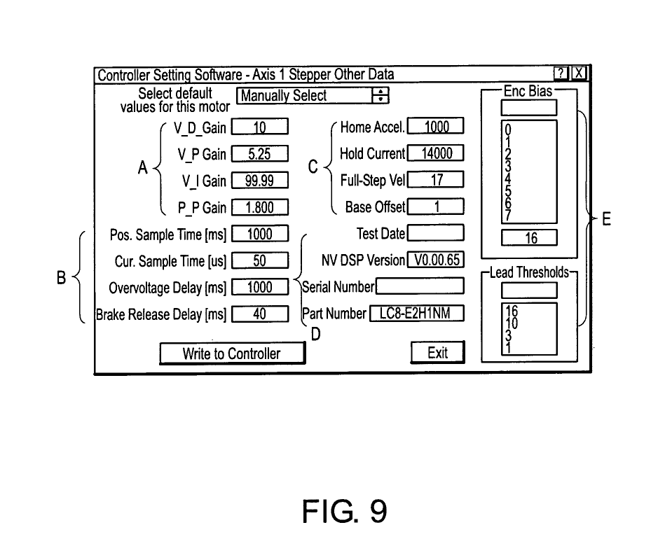

FIG. 8 is a block diagram illustrating the control method used for stepping motor position and speed control using the stepping motor driven actuator 50. The features of the control method are implemented within the controller 138 (see FIG. 4), wherein various parameters used in the software executed by the controller are set via control screens of the human machine interface (HMI), as shall be discussed with reference to FIG. 9.

Major components of the control loop are shown in FIG. 8. A trajectory generator module 10 generates position data for every 1 msec duration upon receiving position, velocity and acceleration data from the HMI. In the closed-loop control mode, the switch 90 is closed, and the position P (proportional) gain block 20 compares the commanded position with position feedback from the encoder 112, and generates an output equal to P×Perror. The output from the P gain block 20 is then input to the velocity PI (proportional & integral) loop. The PI gain block 30 compares the commanded velocity from the trajectory generator 10 with the velocity feedback from the velocity estimator 40, and generates an output that is proportional to the velocity error plus P×Perror. A current and phase compensation control module 55 then implements a control algorithm to generate a sequence of motor torque current (Iqsref) set points, creating a field vector whose magnitude is proportional to Iqsref and whose phase is defined by the rotor position feedback from the encoder 112, along with a phase angle advance based on the rotor velocity, which is output from the lead angle compensator 65. The outputs from the control module 55 are defined as follows: IB is the phase B current, PB is the phase B current direction, IA is the phase A current, and PA is the phase A current direction. The phase A and phase B signals, which excite the phase A windings 75 and the phase B windings 85 respectively, are in quadrature (explained below), as defined by Iqsref×sin(θ) and Iqsref×sin(θ−π/2).

Summarizing the preceding paragraph, the following are mathematical expressions used in the control block illustrated in FIG. 8.
Perror(t)=Commanded Position(t)−Position Feedback(t) (1)
Verror(t)=P×Perror(t)+(Commanded Velocity(t)−Estimated Velocity(t)) (2)
Iqsref(t)=PI×Verror(t) (3)

Next, control screens of the human machine interface (HMI) implemented through the PC 101 shall be explained. As discussed above, existing features of the HMI have already been disclosed in U.S. Pat. No. 6,718,229 and are incorporated herein by reference. An additional control screen of the HMI, which facilitates control of the stepping motor 100 in accordance with the present invention, shall now be explained.

FIG. 9 shows a control screen used for setting and adjusting parameters used in controlling the stepping motor 100. Typically, the values set using this control screen are advanced parameters set by the manufacturer or an installation technician, based upon the specifications of the stepping motors used in any given application. The control screen of FIG. 9 may also be password protected, to limit access to the screen to authorized individuals.

Although only one type of control screen for the stepping motor controller 138 is illustrated in FIG. 9, in fact the HMI software may be used for configuring different types of motor controllers, including but not limited to an AC servo motor controller, a stepping servo motor controller employing the HMI control screen as illustrated in FIG. 9, and a pulse generator that may be used for open-loop driving of a stepping motor. Such different controllers can be used in combination, within the same multi-axis communication setup. In that case, the HMI automatically reads a hardware identification ID stored in each controller and displays an appropriate HMI control screen for each respective controller type.

For example, one axis (axis 1) of a multi-axis actuator system may be operated using an AC servo motor, wherein another axis (axis 2) may be operated using a stepping motor driven in accordance with the principles described in the present specification, and yet another axis (axis 3) may be operated using a stepping motor actuator driven in an open loop mode by a pulse generator. In this case, the controller setting software version, the axis number, and each different type of controller connected to the system may be separately designated. In order to appropriately assign and designate the software appropriate for each different controller, the HMI automatically reads the ID stored in each controller and displays the appropriate HMI screen for each controller type. FIG. 9 shows the HMI screen used for the stepping motor controller 138, which shall now be discussed in further detail.

In particular, the stepper data control screen includes respective text entry boxes, including a text box group A for setting or modifying control loop tuning parameters, a text box group B for setting internal parameters of the digital control loop, a text box group C for setting stepping motor control parameters, a text box group D for setting product data, and a text box group E for setting stepping motor control status parameters.

More specifically, the control loop tuning parameters include velocity damping gain (V_D_Gain), velocity proportional gain (V_P Gain), velocity integral gain (V_I Gain) and position proportional gain (P_P Gain), which are values used in the P gain block 20 and the PI gain block 30 shown in the block diagram of FIG. 8. The internal parameters for the digital control loop may include the position sampling time in milliseconds (Pos. Sample Time [ms]), a motor phase current sampling time in microseconds (Cur. Sample Time [us]), an overvoltage detection delay in milliseconds to properly distinguish fault detection from other noises in the motor voltage (Overvoltage Delay [ms]), and a motor brake release time delay in milliseconds (Brake Release Delay [ms]). The stepping motor control parameters include a home acceleration value used during motor homing (Home Accel.), a motor holding phase current value that is applied when the motor is stopped to maintain the present position (Hold Current), a full step velocity threshold at which the control switches from microstepping into a full-step mode, i.e., the threshold velocities Vₜₕ₁ and Vₜₕ₂ shown in FIG. 7 (Full-Step Vel), and a base offset value used for mechanical alignment of the encoder (Base Offset). The production data includes text boxes for product test date and a firmware version number (NV DSP Version), along with text boxes for a part number and serial number of the product being tested. In particular, default values for a given motor, identified by its serial number and/or part number, may be provided and automatically selected using the selection box at the top of the control screen. Finally, the stepping motor control status boxes may include a text box for an encoder bias value used for monitoring the motor encoder status (Enc Bias), and a text box for lead angle threshold values, which are used for monitoring lead angle points.

Each of the stepping motor control modes, which are used during the different motion stages discussed above in connection with FIG. 8, shall now be described in greater detail. In particular, the respective stepping motor control modes of the present invention are 1) an electrical alignment and base offset measurement mode, 2) an open-loop holding control mode, 3) a closed-loop full-step control mode, and 4) a closed-loop microstepping control mode. In addition, 5) a lead angle compensation technique, which is applied during the closed-loop drive control modes, shall also be described in greater detail below.

1) Electrical Alignment and Base Offset Measurement

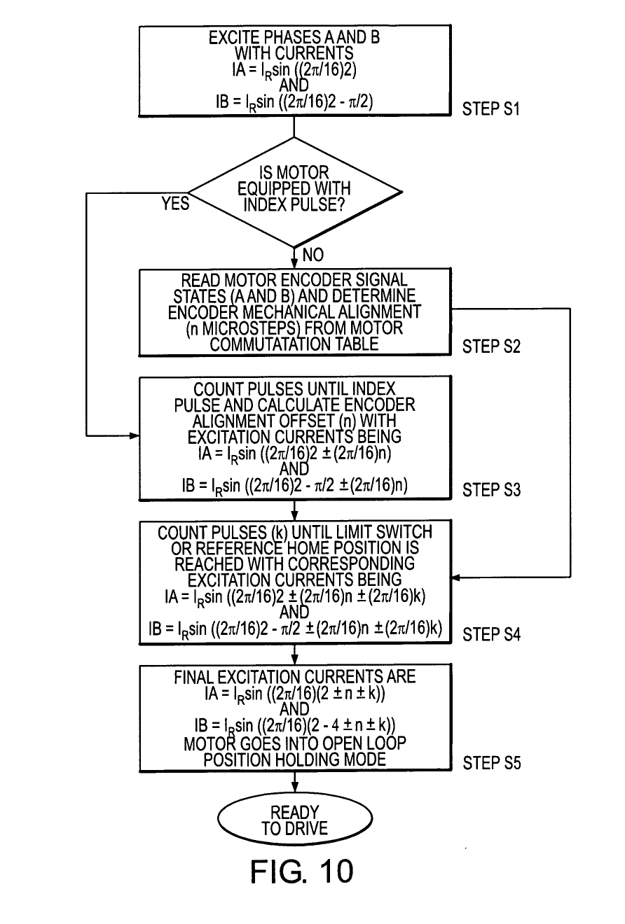

When the stepping motor 100 is powered on, the controller 138 does not know the angular position of the rotor. In order to synchronize the stepping motor rotor with the excitation fields applied for effective driving and maximizing torque, it is important to align them. Alignment can be achieved mechanically or electrically. Mechanical alignment is difficult, time consuming, and prone to error. Electrical alignment is precise and mainly limited by the resolution of the encoder 112. By using a high resolution encoder (e.g., 200 to 1000 lines), this error can be reduced substantially. With reference to the flow chart illustrated in FIG. 10, the following is a description of the electrical alignment procedure as implemented according to the present invention.

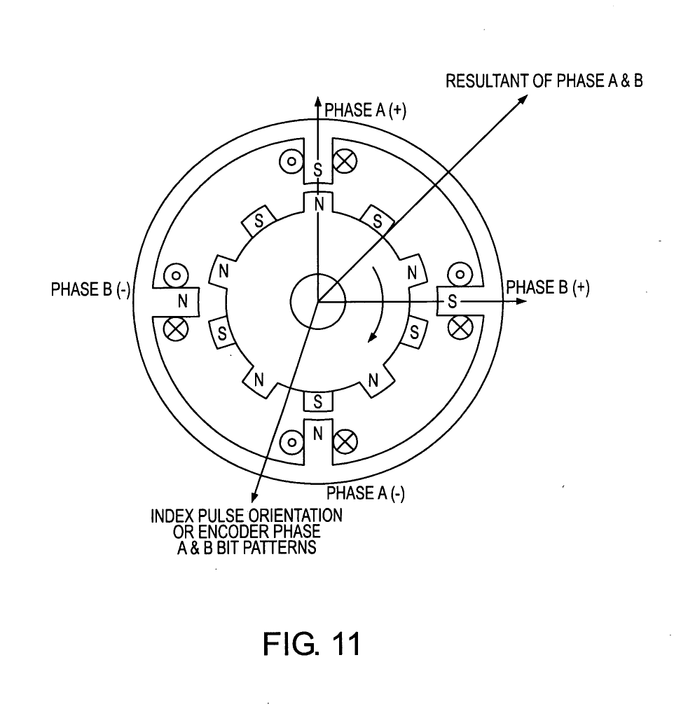

In electrical alignment, in a first STEP S1, both the phase A and B windings are excited with equal currents IA=I_{R} sin ((2π/16)2) and IB=I_{R} sin ((2π/16)2−π/2), where I_{R} is a predetermined rated current, which creates an intermediate magnetic pole and induces the rotor to move. FIG. 11 is a simplified diagram showing this initial state. For example, using a typical 200 step, 1.8° step angle stepping-motor, rotor movement is from 0.9° to 1.8° in either a clockwise or counterclockwise direction. In order to overcome any external load or internal friction that may introduce an offset, it is important to produce sufficient torque, which can be achieved by exciting the phase A and B windings using a sufficient rated current (I_{R}).

Once the rotor is aligned with the stator field, in Step S2, the control software captures the motor encoder state, which are A and B quadrate bit patterns (0 to 3), and then determines the encoder mechanical offset (in terms of the number [n] of microsteps) from the Motor Commutation Table II (see below). Alternatively, in Step S3, if the motor encoder is equipped with the index pulse, in order to determine the number [n] of microsteps, the motor may be rotated in an open-loop mode either in a clockwise or counterclockwise direction to locate the index pulse. Thus, the motor is slowly stepped until the index pulse is detected. Then, the encoder pulses (n counts) are counted and scaled to a sinusoidal current angle as ((2π/16)n) radians. The corresponding excitation currents in this condition are as follows:
IA=I_{R} sin ((2π/16)2±(2π/16)n) (4)
IB=I_{R} sin ((2π/16)2−π/2±(2π/16)n) (5)

Once the encoder mechanical offset (in terms of the number [n] of microsteps) is determined from Step S2, or once the number [n] is determined by detecting the index pulse according to Step S3, then depending on the logic of the controller 138, the motor 100 is rotated in a clockwise or counterclockwise direction until the actuator mechanical hard limit or limit switch (not shown) is detected, in order to find a reference home position. Again, as indicated in Step S4, the pulses are counted (k counts) and the corresponding excitation currents at the limit switch (or the reference home position) are now as follows:
IA=I_{R} sin ((2π/16)2±(2π/16)n±(2π/16)k) (6)
IB=I_{R} sin ((2π/16)2−π/2±(2π/16)n±(2π/16)k) (7)

Upon reaching the limit switch, the motor controller 138 acquires full knowledge of the index pulse, along with the limit switch or the actuator mechanical end limits. In order to maximize the driving torque, as indicated in Step S5, the field excitation is advanced by 16 counts or 1 step in the direction of movement, to result in the following corresponding excitation currents used for driving the motor 100.
IA=I_{R} sin ((2π/16) (2±n±k)) (8)
IB=I_{R} sin ((2π/16) (2−4±n±k)) (9)

At this point, the motor enters an initial open-loop position holding mode and is ready to be driven.

2) Open-Loop Holding Control Mode

As shown in FIG. 8, initially the motor 100 is operated in an open-loop holding mode from time t₀ to t₁, and moreover the motor 100 is again placed in a similar holding mode from time t₄ to t₅ and from time t₈ to t₉. During the holding modes, an open-loop control is used to eliminate motor hunting vibrations, which can occur at low velocities or when coming to a rest in a closed-loop mode. Further, in contrast to when the motor is moving, when the motor is at rest before or after the motor has completed moving, the motor 100 switches from being operated in a quadrature mode (i.e., an implementation of known space vector technology to maximize torque, as shall be discussed below) to an open-loop holding mode. In the holding mode, both the armature and rotor vectors are aligned and there is no torque produced, and therefore the stepping motor 100 stays at its present position. This eliminates vibrations when the stepping motor 100 is not required to move, whereas the quadrature mode maximizes torque when the motor 100 is required to move.

3) Closed-Loop Full-Step Control Mode

As shown in FIG. 8, after the holding mode from time t₀ to t₁, the motor enters into a closed-loop microstepping control mode, prior to reaching a threshold velocity at time t₂, where the control mode is switched to a full-step mode. For better understanding of the microstepping control mode, however, it is helpful first to understand the features of the closed-loop full-step control mode, which occurs from time t₂ to t₃ in FIG. 8.

More specifically, in the full-step control mode, both motor phases A and B are driven at 100% creating a resultant armature field with 141.4% magnitude at 45°, 135°, 225° and 315° orientation. In this mode, the current load is evenly distributed between the two phases, and an extra 41.4% amount of power is produced by the motor 100. This is the preferred control mode when the motor is operated at higher speeds when increased power to the motor 100 is desired. Further, during this control mode, torque is maximized by producing a field vector in quadrature with respect to the rotor field. However, at lower speeds the full-step control mode produces vibrations due to the large steps taken while moving, and therefore the microstepping mode (described below) is used when operating below the threshold velocity value at times t₂, t₃, t₆ and t₇ shown in FIG. 8.

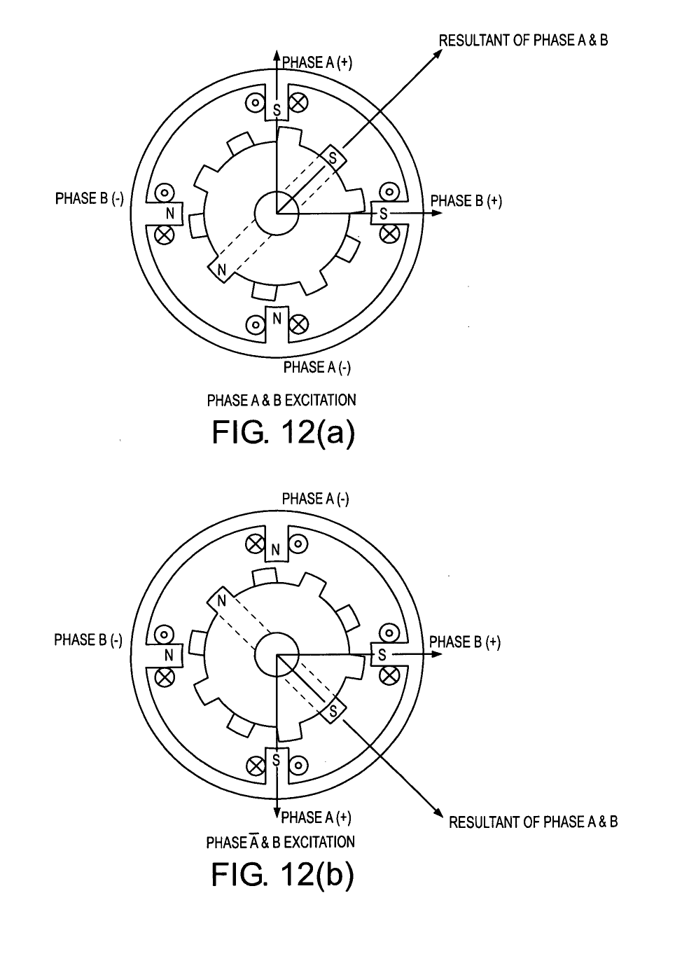

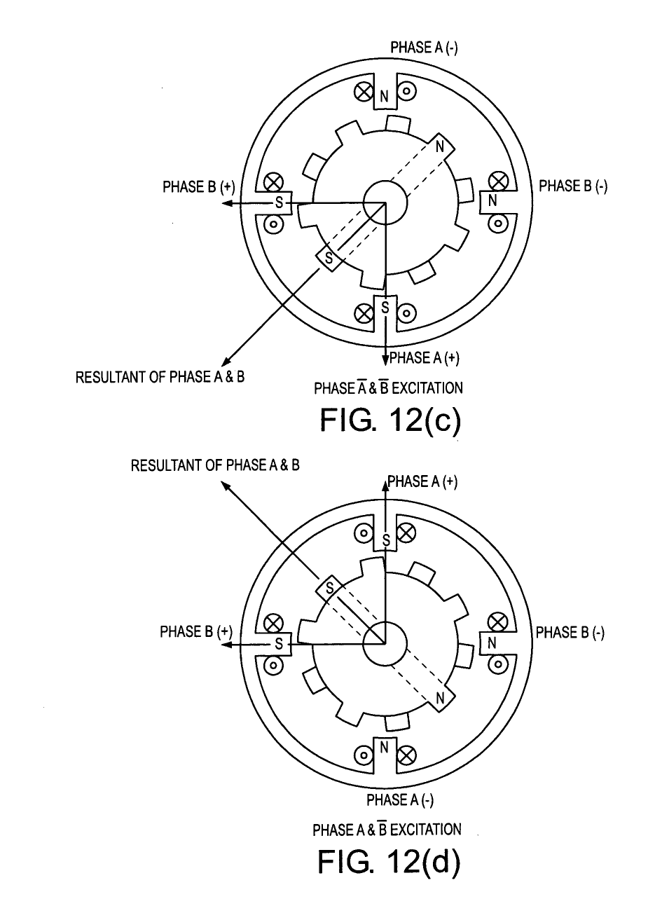

More specifically, to illustrate the full steps of the stepping motor 100, a simplified schematic view of the stepping motor 100 is shown in FIGS. 12(a) to 12(d), which shall be explained with reference to the following table.

TABLE I
Full Step Drive Mode

| Step | Rotor Position | Electromagnetic Field | Energization | |
|---|---|---|---|---|
| 0 | 45° | 45° | + | + |
| 1 | 135° | 135° | − | + |
| 2 | 225° | 225° | − | − |
| 4 | 315° | 315° | + | − |

FIGS. 12(A) to 12(D) show a permanent magnet stepping motor 100, wherein the rotor is shown in simplified form as a bar magnet (indicated by the dashed line), providing two primary rotor poles, surrounded by stator coils with windings provided on each of four poles. In order to position the rotor at 45°, at an initial full-step 0, phases A and B are both energized with equal positive values (phase A & B excitation), and the electromagnetic field is in alignment with the rotor position at 45°. In order to position the rotor at 135°, at the next full-step 1, phase A is energized negatively and phase B is energized positively at equal values (phase A & B excitation), and the electromagnetic field is in alignment with the rotor position at 135°. In order to position the rotor at 225°, at the next full-step 2, phases A and B are both energized with equal negative values (phase A̅ & B̅ excitation), and the electromagnetic field is in alignment with the rotor position at 225°. In order to position the rotor at 315°, at the next full-step 3, phase A is energized positively and phase B is energized negatively at equal values (phase A & B̅ excitation), and the electromagnetic field is in alignment with the rotor position at 315°. Therefore, during the full-step driving mode, the rotor is rotated a full 360° every four full-steps.

4) Closed-Loop Microstepping Control Mode

A two hundred encoder line per revolution stepping motor with two-phase stator coils has 50 rotor teeth (i.e., 50 poles) provided for each rotor. For a 200-line encoder, each encoder count therefore represents one fourth of a full-step. Therefore, in the microstepping mode, the motor 100 can be driven with four steps per each full-step, or in other words, a full rotation of the motor is produced per each 16 steps in the microstepping control mode. That is, since each full electrical cycle consists of four full steps as described in the preceding paragraph, there are sixteen micro-steps per each 360° cycle of the motor 100, or 22.5° degrees per each micro-step.

The encoder count (rotor position) is mapped to the microstep (μStep) angle (0 to 15 counts) according to the following modulo equation (1), wherein the lead angle is determined as discussed in the next section.
μstep=mod(Encoder Count+Lead Angle, 16) (10)

Table II is the motor phase (A, B) commutation table, wherein the μStep count appears as an index to a table of Phase A and Phase B percentage values corresponding to each μStep value.

TABLE II
Motor Phase A & B Commutation Table

| μStep | Quadrant | Phase A = cos(θ) | Phase B = sin(θ) | θ |
|---|---|---|---|---|
| 0 | 0 | 100% | 0% | 0° |
| 1 | 0 | 92.39% | 38.27% | 22.5° |
| 2 | 0 | 70.7% | 70.7% | 45° |
| 3 | 0 | 38.27% | 92.39% | 67.7° |
| 4 | 1 | 0% | 100% | 90° |
| 5 | 1 | −38.27% | 92.39% | 112.5° |
| 6 | 1 | −70.7% | 70.7% | 135° |
| 7 | 1 | −92.39% | 38.27% | 157.5° |
| 8 | 2 | −100% | 0% | 180° |
| 9 | 2 | −92.39% | −38.27% | 202.5° |
| 10 | 2 | −70.7% | −70.7% | 225° |
| 11 | 2 | −38.27% | −92.39% | 247.5° |
| 12 | 3 | 0% | −100% | 270° |
| 13 | 3 | 38.27% | −92.39% | 292.5° |
| 14 | 3 | 70.7% | −70.7% | 315° |
| 15 | 3 | 92.39% | −38.27% | 337.5° |

By using microstepping in a low to medium speed range, smoother driving of the actuator 50 is made possible by reducing overshooting and actuator vibration.

During both the closed-loop microstepping and full-step control modes, i.e., when executing moves, the stepping motor 100 operates in quadrature, which is a known implementation of space vector theory as discussed above. More specifically, the motor armature and rotor field vectors are maintained orthogonal to each other to produce maximum torque. While the stepping motor 100 is driven in a closed loop, based on feedback from the encoder 112, the stator phases are activated to maintain the 90° phase advance and produce maximum torque. In particular, at low speeds, a 90° phase advance is optimum, however, as the speed of the motor 100 increases, the currents in the motor windings cannot keep up with actual motor rotation because of coil inductance. As a result, the lead angle has to be advanced through a lead angle compensation technique to allow for current build up at higher speeds.

The lead angle compensation technique, which is implemented via a look up table stored in the lead angle compensator 60, shall now be discussed.

5) Phase Advance (Lead Angle) Technique

The relation between the rotor's present position and the phases to be excited is specified in terms of lead angle. For example, consider a two-phase motor driven in one phase excitation full-step mode. The sequence of excitation is represented by PH1→PH2→PH1(−)→PH2(−). First PH1 is excited and the rotor is aligned with PH1 in an equilibrium position. Then PH2 is excited and PH1 is de-energized to run the motor. The lead angle in this case is one (1) step. As soon as the position encoder detects that the rotor has reached an equilibrium position of PH2, the next phase PH1(−) is excited and the motor continues to run.

This scheme of running the stepper motor works well at low speeds and also maximizes the torque produced. However, as the motor speed increases, it takes more time for the current to rise and reach its full magnitude, due to winding inductance. Specifically, the motor current supplied to the windings rises over time based on an electrical time constant of the drive circuit.

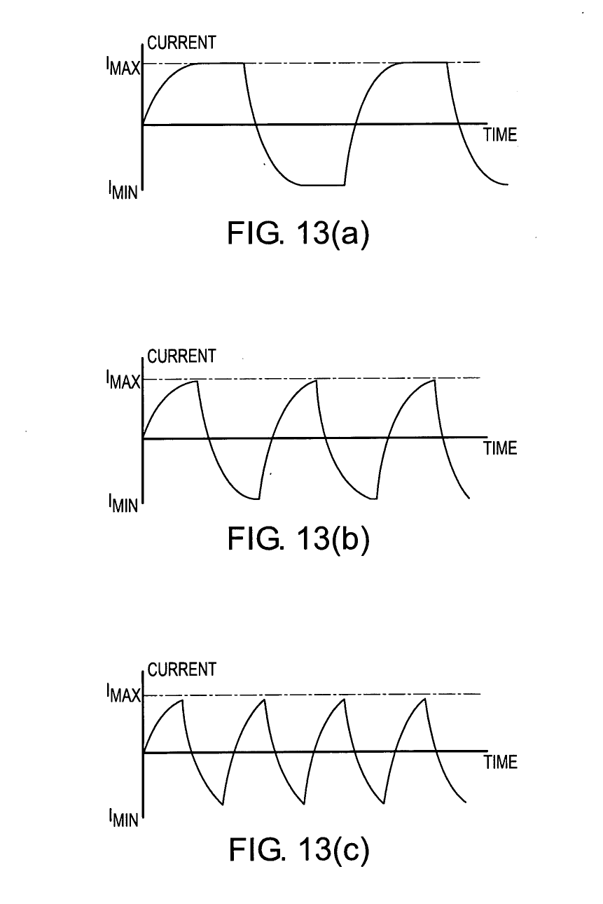

FIGS. 13(A) to 13(C) show the current response for a square wave voltage input at three different frequencies, representing increasing motor speeds. Above a certain frequency, as shown in FIG. 13(B), the current never reaches its maximum value (Iₘₐₓ=6.5 C). Since the torque of the motor is approximately proportional to the current, the maximum torque is reduced as the stepping frequency increases. As the speed increases, the average value of the current decreases and the average torque is reduced. In order to increase the period of torque production and hence the average current, the phases need to be turned on earlier, in effect resulting in advancement of the lead angle. Thus, as speed increases, to offset the current lag, the excitation phase is advanced. As the phase is advanced the back EMF reflected at the terminal is reduced and hence allows for more current, which in turn increases the value of average torque.

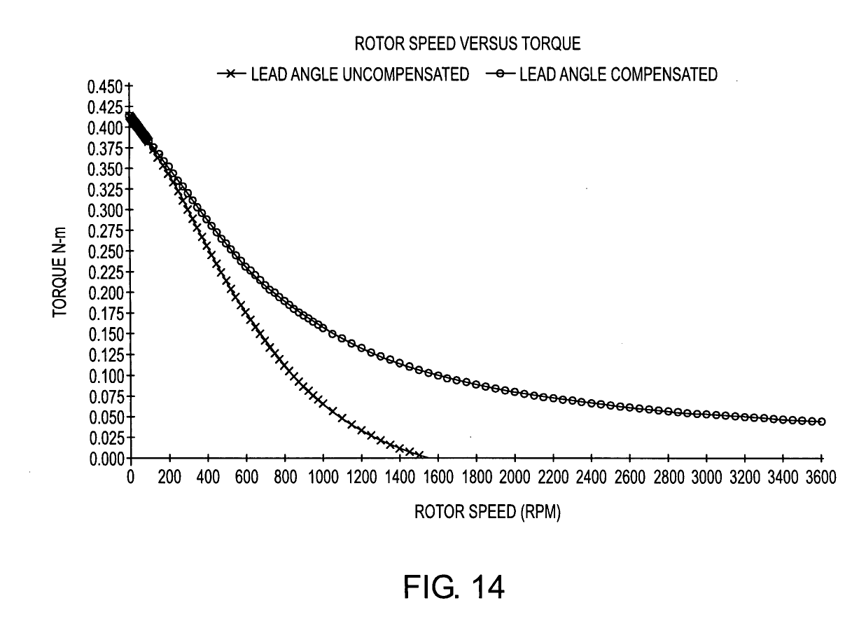

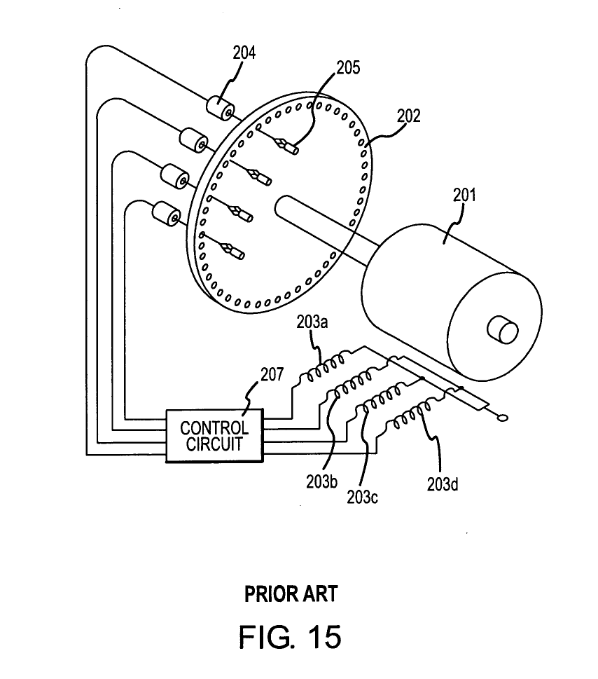

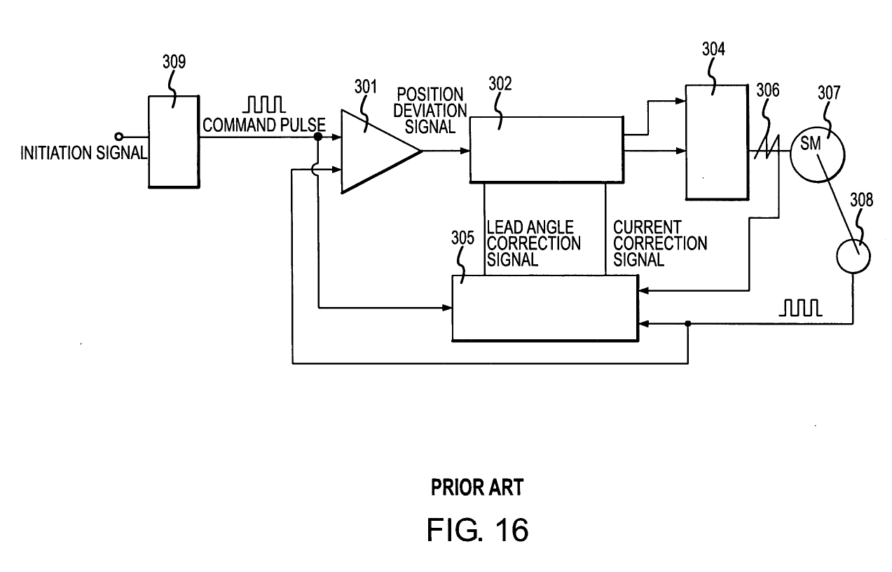

In the present invention, the phase current lag ν is computed as ν=−arctan (ωe×L/R) radians, where ωe is the frequency of the back EMF, L is the inductance of the winding, and R is the resistance of the winding. When the excitation currents are advanced by the phase current lag angle, as shown in FIG. 14, the effect is to increase the torque at that speed.

According to the present invention, the phase lead angle ν is computed in accordance with the above, and respective lead angle compensation values are stored in a look up table maintained in the lead angle compensator 65 shown in FIG. 8. Exemplary phase lead angle compensation values used, depending on the motor speed (RPM), for a 200 line per revolution encoder, are as shown in the following table.

TABLE III
Lead Angle Compensation Values
(200 line per revolution encoder)

| Motor Speed (RPM) | Phase Lead Angle (radians) |
|---|---|
| 0 ≦ RPM < 85 | ν = π/4 |
| 85 ≦ RPM < 225 | ν = 2 × π/4 |
| 225 ≦ RPM < 750 | ν = 3 × π/4 |
| 750 ≦ RPM < 1200 | ν = 4 × π/4 |

Referring back to the section above discussing offset compensation and equations (9) and (10), when the motor is driven in the closed-loop mode, the excitation currents IA and IB, including the phase advance compensation ν, are calculated as follows:
IA=I_{R} sin ((2π/16) (2±n±k))±ν (11)
IB=I_{R} sin ((2π/16) (2−4±n±k))±ν (12)
The symbol ± is either negative or positive depending on the direction of rotation.

The principal features of the present invention have been described. Significant advantages of the invention are achieved in that motor hunting and motor vibrations are reduced when the motor is placed in a position holding mode, microstepping is used during low to medium velocities to prevent overshooting and actuator vibration, and a closed-loop full-step mode is used effectively at higher velocities, while applying lead angle compensation, to keep the stator and rotor fields in quadrature while producing maximum torque across a wide RPM range.

The stepping motor driver and control method may also include other closed-loop phase current controls in addition to microstepping, which depend on the motor torque or load requirements, in order to minimize torque ripples and excessive power dissipations. In contrast, open-loop stepper drivers usually set the phase current close to 100% regardless of torque or load requirements. In the present invention, torque or load requirements are computed by the PIP (velocity proportional, integral, and position) control loop described above. The required motor torque is calculated by finding the difference between the commanded and actual velocities, as well as the commanded and current positions.

It shall be understood that other modifications will be apparent and can be easily made by persons skilled in the art without departing from the scope and spirit of the present invention. Accordingly, the following claims shall not be limited by the descriptions or illustrations set forth herein, but shall be construed to cover with reasonable breadth all features that may be envisioned as equivalents by those skilled in the art.

What is claimed is:

1. A stepping motor control system, comprising:
a stepping motor with an encoder connected to said stepping motor;
a current and phase compensation controller, which receives an output from said encoder, wherein said controller implements a lead angle compensation routine, microstepping and full-step motor driving modes during closed-loop driving of said stepping motor, and an open-loop position holding mode when said stepping motor is at rest;
a trajectory generator for sending a velocity motion profile to said current and phase compensation controller, said motion profile having rest, acceleration and constant velocity stages,
wherein when said stepping motor moves at a velocity lower than a predetermined velocity threshold, said stepping motor is operated in the microstepping driving mode, and when said stepping motor moves at a velocity above said velocity threshold, said stepping motor is operated in the full-step driving mode.

2. The stepping motor control system according to claim 1, further comprising:
a velocity feedback loop comprising a velocity estimator connected to said encoder and which outputs an estimated velocity based on a position signal output from said encoder, a PI (proportional and integral) gain block which compares the estimated velocity with a commanded velocity output by said trajectory generator, wherein said PI gain block outputs a velocity error signal to said current and phase compensation controller; and
a position feedback loop comprising a P (proportional) gain block connected to said encoder and which compares the position signal output from said encoder with a commanded position output by said trajectory generator, wherein said P gain block outputs a position error signal to said PI gain block of said velocity feedback loop,
wherein said position feedback loop includes a switch for opening and closing said position feedback loop, said switch being opened to initiate said open-loop position holding mode when said stepping motor is at rest.

3. The stepping motor control system according to claim 1, wherein said stepping motor comprises a two-phase stepping motor, said current and phase compensation controller outputting a pair of stator phase current signals (IA, IB) respectively to an excitation circuit for A and B phase windings of said stepping motor, and outputting a pair of phase current direction signals (PA, PB) respectively to said excitation circuit.

4. The stepping motor control system according to claim 2, further comprising a lead angle compensator connected to said velocity estimator, and which outputs a lead angle compensation signal (ν) to said current and phase compensation controller, wherein said lead angle compensation signal increases depending on the rotational speed of said stepping motor.

5. The stepping motor control system according to claim 1, wherein said stepping motor is contained in an actuator making up one of a plurality of actuators of a multi-axis actuator setup, each of said actuators being connected to respective motor controllers.

6. The stepping motor control system according to claim 5, further comprising a human machine interface (HMI) program for supplying control parameters to each of said respective motor controllers.

7. The stepping motor control system according to claim 6, wherein each of said respective motor controllers stores a hardware identification ID therein, and said human machine interface program reads said hardware identification ID from each of said motor controllers and displays a control screen for each respective motor controller.

8. A method for controlling a stepping motor connected to an encoder, comprising the steps of:
supplying a velocity motion profile, said motion profile having rest, acceleration and constant velocity stages, for driving said stepping motor;
holding said stepping motor in an open-loop position holding control mode when said stepping motor is at rest;
driving said stepping motor in a closed-loop microstepping mode when said stepping motor moves at a velocity lower than a predetermined threshold velocity; and
driving said stepping motor in a closed-loop full-step mode when said stepping motor moves at a velocity higher than said predetermined velocity threshold.

9. The method according to claim 8, said stepping motor comprising a two-phase stepping motor, wherein prior to entering an initial closed-loop driving mode, alignment and base offset measurement of said stepping motor are performed, comprising the steps of:
exciting respective phase windings of said stepping motor with equal excitation current magnitudes, IA=I_{R} sin ((2π/16)2) and IB=I_{R} sin ((2π/16)2−π/2), wherein I_{R} is a predetermined rated current;
determining a number of microsteps (n) required for mechanical alignment of said stepping motor;
rotating said stepping motor in said open loop mode, until a reference home position of said actuator is detected while counting a number of pulses (k) required to reach said reference home position, wherein the respective excitation currents IA and IB become IA=I_{R} sin ((2π/16)2±(2π/16)n±(2π/16)k) and IB=I_{R} sin ((2π/16)2−π/2±(2π/16)n±(2π/16)k); and
advancing the excitation currents IA and IB by a predetermined number of counts in order to maximize driving torque, whereupon said stepping motor goes into an initial open loop position holding mode.

10. The method according to claim 9, wherein the step of determining the number of microsteps (n) required for mechanical alignment further comprises reading current signal states of respective phases of said stepping motor, and determining said number of microsteps (n) from a motor commutation table.

11. The method according to claim 9, wherein the step of determining the number of microsteps (n) required for mechanical alignment further comprises rotating said stepping motor in an open loop mode until an index pulse is detected, while said microsteps (n) are determined by counting a number of pulses required to reach said index pulse, wherein the respective excitation currents IA and IB become IA=I_{R} sin ((2π/16)2±(2π/16)n) and IB=I_{R} sin ((2π/16)2−π/2±(2π/16)n).
